(19) United States
(12) Patent Application Publication
(10) Pub. No.: US 2006/0235664 A1
(43) Pub. Date: Oct. 19, 2006

(54) Model-based capacity planning

(75) Inventors: Anders B. Vinberg, Kirkland, WA (US); Bassam Tabbara, Seattle, WA (US); Kevin Grealish, Seattle, WA (US); Rob Mensching, Redmond, WA (US); Geoffrey Outhred, Seattle, WA (US); Galen C. Hunt, Bellevue, WA (US); Aamer Hydrie, Seattle, WA (US); Robert V. Welland, Seattle, WA (US); Efstathios Papaefstathiou, Redmond, WA (US); Jonathan C. Hardwick, Kirkland, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/107,418

(22) Filed: Apr. 15, 2005

(51) Int. Cl. G06G 7/48

(52) U.S. Cl. 703/6

(57) ABSTRACT

Model-based capacity planning includes accessing a model of a planned system that includes multiple components. Relationships among the multiple components are identified based on the model of the system. Transactions to be performed by the planned system are identified along with a cost associated with each of the identified transactions. Operation of the planned system is simulated using the model of the planned system and the identified costs.

### TECHNICAL FIELD

The invention relates to capacity planning, and more particularly to model-based capacity planning.

### BACKGROUND

Computers have become increasingly commonplace in our world and offer a variety of different functionality. Some computers are designed primarily for individual use, while others are designed primarily to be accessed by multiple users and/or multiple other computers concurrently. These different functionalities are realized by the use of different hardware components as well as different software applications that are installed on the computers.

Although the variety of available computer functionality and software applications is a tremendous benefit to the end users of the computers, such a wide variety can be problematic for the developers of the software applications as well as system administrators that are tasked with keeping computers running. Many computing systems contain a large number of different components that must work together and function properly for the entire computing system to operate properly. The demands on a computing system vary depending on one or more factors, such as the number of users accessing the computing system, the number of applications running on the computing system, the number of tasks or operations being performed by the computing system, and the capacities of various components in the computing system. System administrators need to configure and equip computing systems to handle current processing loads and, at times, may need to re-configure or plan for future processing requirements (e.g., due to additional users, increased numbers of tasks or operations being performed, and the like).

Accordingly, it would be beneficial to allow a user to plan for future capacity in a computing system.

### SUMMARY

Model-based capacity planning is described herein.

In accordance with certain aspects, a process accesses a model of a planned system that includes multiple components. The process identifies relationships among the multiple components based on the model of the system. The process further identifies transactions to be performed by the planned system and a cost associated with each of the identified transactions. Operation of the planned system is simulated using the model of the planned system and the identified costs.

### BRIEF DESCRIPTION OF THE DRAWINGS

The same numbers are used throughout the drawings to reference like features.

FIG. 1 illustrates an example system definition model (SDM) that can be used with the model-based system monitoring described herein.

FIG. 2 illustrates an example use of types, configurations, and instances.

FIG. 3 is a flowchart illustrating an example process for capacity planning.

FIG. 4 illustrates example transactions that are performed by a planned system.

FIG. 5 illustrates an example general computer environment, which can be used to implement the techniques described herein.

### DETAILED DESCRIPTION

Model-based capacity planning is described herein. A user can define a planned system and simulate the operation of various transactions on the system without having to actually create or test the planned system. A model of the planned system defines various components in the planned system and defines relationships between those components. A capacity planning algorithm simulates operation of the planned system based on the model and one or more costs associated with transactions executed by the planned system.

As used herein, an application refers to a collection of instructions that can be executed by a processor, such as a central processing unit (CPU) of a computing device. An application can be any of a variety of different types of software or firmware, or portions thereof. Examples of applications include programs that run on an operating system, the operating system, operating system components, services, infrastructure, middleware, portions of any of these, and so forth.

The systems and methods described herein are capable of estimating the performance and capability of a managed system. These estimations are useful in determining current and future system requirements to meet the requirements of certain types and quantities of transactions handled by the system. This capacity planning simplifies the selection of components (and component capacities) for the system and allows the various components to be tested in an expected operating environment prior to actually implementing the system. The systems and methods described herein also permit various capacity planning activities using different system architectures defined by one or more system models.

A system definition model (SDM) describes a system that can be managed. Management of a system can include, for example, installing software on the system, monitoring the performance of the system, maintaining configuration information about the system, verifying that constraints within the system are satisfied, combinations thereof, and so forth. A system can be, for example, an application, a single computing device, multiple computing devices networked together (e.g., via a private or personal network such as a local area network (LAN) or via a larger network such as the Internet), and so forth.

In a particular implementation, the SDM is created, for example, by a developer having knowledge of the various components, relationships, and other aspects of the system being defined. In this implementation, the developer has intimate knowledge of the various components in the system and how they interact with one another. This knowledge is useful in defining the manner in which the various components are monitored or otherwise managed.

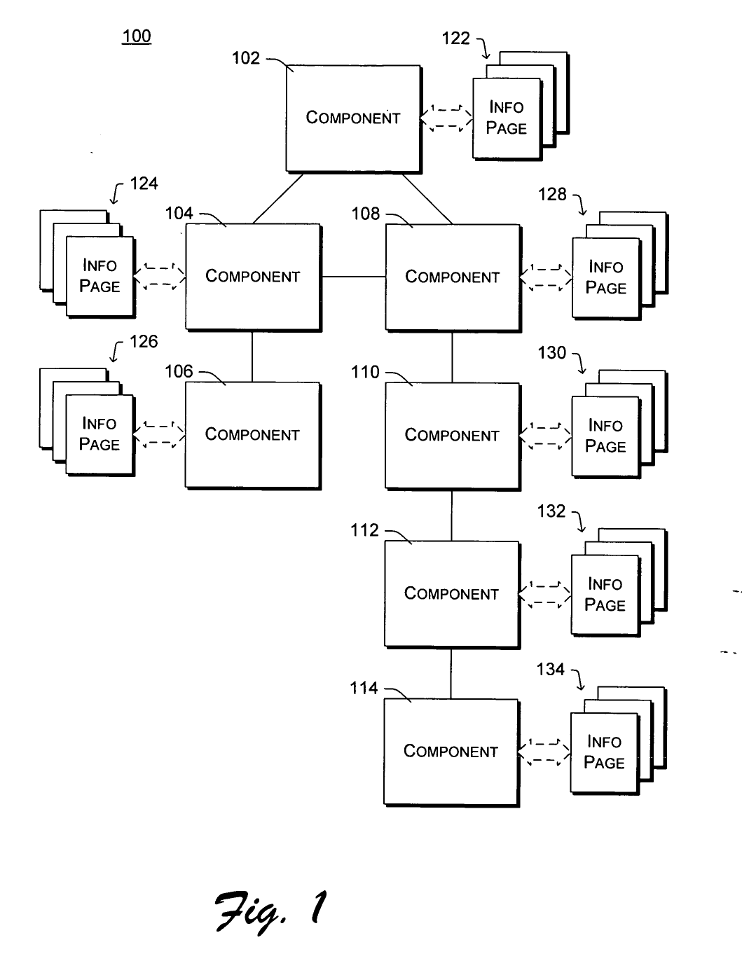

FIG. 1 illustrates an example SDM 100 that can be used with the model-based system monitoring described herein. SDM 100 includes a component corresponding to each of one or more software and/or hardware components being managed in a system. These software and/or hardware components being managed refer to those software and/or hardware components that the author of SDM 100 and/or designers of the system desire to include in SDM 100. Examples of hardware and/or software components that could be in a system include an application (such as a database application, email application, file server application, game, productivity application, operating system, and so forth), particular hardware on a computer (such as a network card, a hard disk drive, one of multiple processors, and so forth), a virtual machine, a computer, a group of multiple computers, and so on. A system refers to a collection of one or more hardware and/or software components.

SDM 100 represents a system including component 102, component 104, component 106, component 108, component 110, component 112, and component 114. Although the example SDM 100 includes seven components, in practice a system, and thus the SDM, can include any number of components.

For example, component 106 could represent a particular computer, while component 104 represents an operating system running on that particular computer. By way of another example, component 106 could represent an operating system, while component 104 represents a database application running on the operating system. By way of yet another example, component 114 could represent a particular computer, while component 112 represents an operating system installed on that particular computer, component 110 represents a virtual machine running on the operating system, and component 108 represents an operating system running on the virtual machine. Note that the operating systems associated with component 112 and component 108 could be the same or alternatively two different operating systems.

The SDM is intended to be a comprehensive knowledge store, containing all information used in managing the system. This information includes information regarding the particular components in the system, as well as relationships among the various components in the system. Despite this intent, it is to be appreciated that the SDM may contain only some of the information used in managing the system rather than all of the information.

Relationships can exist between different components in a system, and these relationships are illustrated in the SDM with lines connecting the related components. Examples of relationships that can exist between components include containment relationships, hosting relationships, and communication relationships. Containment relationships identify one component as being contained by another component—data and definitions of the component being contained are incorporated into the containing component. When a component is installed on a system, any components contained in that component are also installed on the system. In FIG. 1, containment relationships are illustrated by the diagonal lines connecting component 102 and component 104, and connecting component 102 and component 108.

Hosting relationships identify dependencies among components. In a hosting relationship, the hosting component should be present in order for the guest component to be included in the system. In FIG. 1, hosting relationships are illustrated by the vertical lines connecting component 104 and component 106, connecting component 108 and component 110, connecting component 110 and 112, and connecting component 112 and 114.

Communication relationships identify components that can communicate with one another. In FIG. 1, communication relationships are illustrated by the horizontal line connecting component 104 and component 108.

Associated with each component in SDM 100 is one or more information (info) pages. Information pages 122 are associated with component 102, information pages 124 are associated with component 104, information pages 126 are associated with component 106, information pages 128 are associated with component 108, information pages 130 are associated with component 110, information pages 132 are associated with component 112, and information pages 134 are associated with component 114. Each information page contains information about the associated component. Different types of information can be maintained for different components. One or more information pages can be associated with each component in SDM 100, and the particular information that is included in a particular information page can vary in different implementations. All the information can be included on a single information page, or alternatively different pieces of information can be grouped together in any desired manner and included on different pages. In certain embodiments, different pages contain different types of information, such as one page containing installation information and another page containing constraint information. Alternatively, different types of information may be included on the same page, such as installation information and constraint information being included on the same page.

Examples of types of information pages include installation pages, constraint pages, monitoring pages, service level agreement pages, description pages, and so forth. Installation pages include information describing how to install the associated component onto another component (e.g., install an application onto a computer), such as what files to copy onto a hard drive, what system settings need to be added or changed (such as data to include in an operating system registry), what configuration programs to run after files are copied onto the hard drive, sequencing specifications that identify that a particular installation or configuration step of one component should be completed before and installation or configuration step of another component, and so forth.

Constraint pages include information describing constraints for the associated component, including constraints to be imposed on the associated component, as well as constraints to be imposed on the system in which the associated component is being used (or is to be used). Constraints imposed on the associated component are settings that the component should have (or alternatively should not have) when the component is installed into a system. Constraints imposed on the system are settings (or other configuration items, such as the existence of another application or a piece of hardware) that the system should have (or alternatively should not have) in order for the associated component to be used in that particular system.

It should also be noted that constraints can flow across relationships. For example, constraints can identify settings that any component that is contained by the component, or that any component that contains the component, should have (or alternatively should not have). By way of another example, constraints can identify settings that any component that is hosted by the component, or that any component that hosts the component, should have (or alternatively should not have). By way of yet another example, constraints can identify settings that any component that communicates with the component should have (or alternatively should not have).

In addition, constraint pages may also include a description of how particular settings (or components) are to be discovered. For example, if a constraint indicates that an application should not co-exist with Microsoft® SQL Server, then the constraint page could also include a description of how to discover whether Microsoft® SQL Server is installed in the system. By way of another example, if a constraint indicates that available physical memory should exceed a certain threshold, then the constraint page could also include a description of how to discover the amount of available physical memory in the system. By way of still another example, if a constraint indicates that a security setting for Microsoft® SQL Server should have a particular value, then the constraint page could also include a description of how to discover the value of that security setting for Microsoft® SQL Server.

Constraint pages may also include a description of how particular settings are to be modified if they are discovered to not be in compliance with the constraints. Alternatively, the constraint pages could include specifications of some other action(s) to take if particular settings are discovered to not be in compliance with the constraints, such as sending an event into the system's event log, alerting an operator, starting a software application to take some corrective action, and so forth. Alternatively, the constraint pages could include a policy that describes what action to take under various circumstances, such as depending on the time of day, depending on the location of the system.

Constraint pages may also optionally include default values for at least some of these settings, identifying a default value to use within a range of values that satisfy the constraint. These default values can be used to assist in installation of an application, as discussed in more detail below.

Monitoring pages include information related to monitoring the performance and/or health of the associated component. This information can include rules describing how the associated component is to be monitored (e.g., what events or other criteria to look for when monitoring the component), as well as what actions to take when a particular rule is satisfied (e.g., record certain settings or what events occurred, sound an alarm, etc.).

Service level agreement pages include information describing agreements between two or more parties regarding the associated component (e.g., between the purchaser of the associated component and the seller from which the associated component was purchased). These can be accessed during operation of the system to determine, for example, whether the agreement reached between the two or more parties is being met by the parties.

Description pages include information describing the associated component, such as various settings for the component, or other characteristics of the component. These settings or characteristics can include a name or other identifier of the component, the manufacturer of the component, when the component was installed or manufactured, performance characteristics of the component, and so forth. For example, a description page associated with a component that represents a computing device may include information about the amount of memory installed in the computing device, a description page associated with a component that represents a processor may include information about the speed of the processor, a description page associated with a component that represents a hard drive may include information about the storage capacity of the hard drive and the speed of the hard drive, and so forth.

As can be seen in FIG. 1, an SDM maintains various information (e.g., installation, constraints, monitoring, etc.) regarding each component in the system. Despite the varied nature of these information pages, they are maintained together in the SDM and thus can all be readily accessed by various utilities or other applications involved in the management of the system.

An SDM can be generated and stored in any of a variety of different ways and using any of a variety of different data structures. For example, the SDM may be stored in a database. By way of another example, the SDM may be stored in a file or set of multiple files, the files being encoded in XML (Extensible Markup Language) or alternatively some other form. By way of yet another example, the SDM may not explicitly stored, but constructed each time it is needed. The SDM could be constructed as needed from information existing in other forms, such as installation specifications.

In certain embodiments, the SDM is based on a data structure format including types, instances, and optionally configurations. Each component in the SDM corresponds to or is associated with a type, an instance, and possibly one or more configurations. Additionally, each type, instance, and configuration corresponding to a particular component can have its own information page(s). A type refers to a general template having corresponding information pages that describe the component generally. Typically, each different version of a component will correspond to its own type (e.g., version 1.0 of a software component would correspond to one type, while version 1.1 of that software component would correspond to another type). A configuration refers to a more specific template that can include more specific information for a particular class of the type. An instance refers to a specific occurrence of a type or configuration, and corresponds to an actual physical component (software, hardware, firmware, etc.).

For types, configurations, and instances associated with a component, information contained in information pages associated with an instance can be more specific or restrictive than, but generally cannot contradict or be broader than, the information contained in information pages associated with the type or the configuration. Similarly, information contained in information pages associated with a configuration can be more specific or restrictive than, but cannot contradict or be broader than, the information contained in information pages associated with the type. For example, if a constraint page associated with a type defines a range of values for a buffer size, the constraint page associated with the configuration or the instance could define a smaller range of values within that range of values, but could not define a range that exceeds that range of values.

It should be noted, however, that in certain circumstances a model of an existing system as deployed (that is, a particular instance of a system) may violate the information contained in information pages associated with the type for that existing system. This situation can arise, for example, where the system was deployed prior to an SDM for the system being created, or where a user (such as a system administrator) may have intentionally deployed the system in noncompliance with the information contained in information pages associated with the type for that existing system.

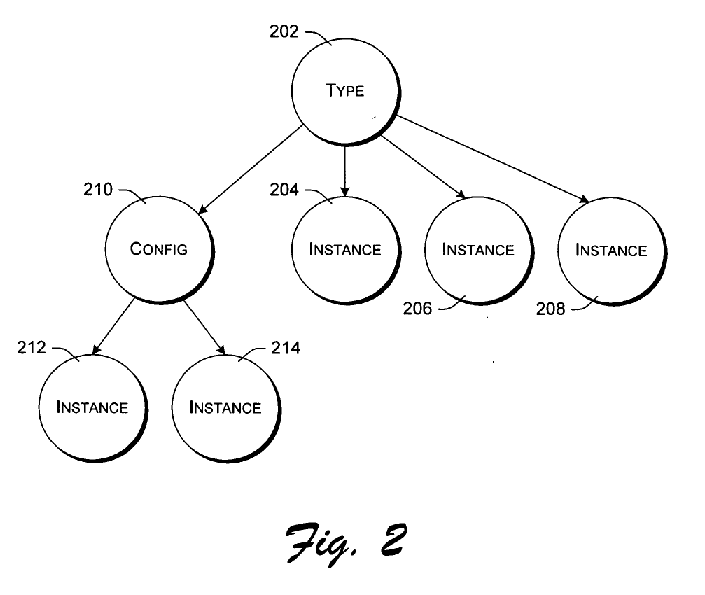

The use of types, configurations, and instances is illustrated in FIG. 2. In FIG. 2, a type 202 corresponds to a particular component. Three different instances 204, 206, and 208 of that particular component exist and are based on type 202. Additionally, a configuration (config) 210 exists which includes additional information for a particular class of the particular component, and two instances 212 and 214 of that particular class of the particular component.

For example, assume that a particular component is a database application. A type 202 corresponding to the database application is created, having an associated constraint information page. The constraint information page includes various general constraints for the database application. For example, one of the constraints may be a range of values that a particular buffer size should be within for the database application. Type 202 corresponds to the database application in general.

Each of the instances 204, 206, and 208 corresponds to a different example of the database application. Each of the instances 204, 206, and 208 is an actual database application, and can have its own associated information pages. For example, each instance could have its own associated description information page that could include a unique identifier of the particular associated database application. By way of another example, the constraint information page associated with each instance could include a smaller range of values for the buffer size than is indicated in the constraint information page associated with type 202.

The information pages corresponding to the instances in FIG. 2 can be in addition to, or alternatively in place of, the information pages corresponding to the type. For example, two constraint information pages may be associated with each instance 204, 206, and 208, the first constraint information page being a copy of the constraint information page associated with type 202 and the second constraint information page being the constraint information page associated with the particular instance and including constraints for just that instance. Alternatively, a single constraint information page may be associated with each instance 204, 206, and 208, the single constraint information page including the information from the constraint information page associated with type 202 as well as information specific to the particular instance. For example, the range of values that the particular buffer size should be within for the database application would be copied from the constraint information page associated with type 202 to the constraint information page associated with each instance. However, if the constraint information page for the instance indicated a different range of values for that particular buffer size, then that different range of values would remain in the constraint information page associated with the instance rather than copying the range of values from the constraint information page associated with type 202.

Following this example of a database application, configuration 210 corresponds to a particular class of the database application. For example, different classes of the database application may be defined based on the type of hardware the application is to be installed on, such as different settings based on whether the computer on which the database application is to be installed is publicly accessible (e.g., accessible via the Internet), or based on whether an operating system is already installed on the server. These different settings are included in the constraint information page associated with configuration 210.

Each of the instances 212 and 214 corresponds to a different example of the database application. Similar to instances 204, 206, and 208, each of instances 1212 and 214 is an actual database application product, and can have its own information page(s). However, unlike instances 204, 206, and 208, the constraint information pages associated with instances 212 and 214 each include the constraints that are in the constraint information page associated with configuration 210 as well as the constraints in the constraint information page associated with type 202.

It should be noted that, although the information pages are discussed as being separate from the components in the SDM, the data structure(s) implementing the SDM could alternatively include the information discussed as being included in the various information pages. Thus, the component data structures themselves could include the information discussed as being included in the various information pages rather than having separate information pages.

The installation page associated with a component can be used as a basis for provisioning a system. Provisioning a system refers to installing an application(s) on the system, as well as making any necessary changes to the system in order for the application(s) to be installed. Such necessary changes can include, for example, installing an operating system, installing one or more other applications, setting configuration values for the application or operating system, and so forth.

In the discussions herein, reference is made to different classes of computing devices. Each of these different classes of computing devices refers to computing devices having particular common characteristics, so they are grouped together and viewed as a class of devices. Examples of different classes of devices include IIS (Internet Information Services) servers that are accessible to the Internet, IIS servers that are accessible only on an internal intranet, database servers, email servers, order processing servers, desktop computers, and so forth. Typically, each different class of computing device corresponds to one of the configurations in the system model.

Capacity planning allows users to manage future software and hardware requirements proactively instead of reactively. Capacity planning is part of a performance modeling process that guides a user's decision-making process before application deployment, and continues to assist them after deployment in predicting the application's behavior under changing loads, identifying future bottlenecks, and experimenting with other “what if” scenarios. Example “what if” scenarios include anticipated company growth, increased network traffic, increased database access requests, and new applications or features provided by the system. Accurate and simple capacity planning is useful in server consolidation and virtualization scenarios. Proper capacity planning can avoid the over-provisioning of resources to ensure correct operation. Instead, proper capacity planning can identify the appropriate resources to correctly perform the desired operations.

Capacity planning uses the data contained in the SDM discussed herein. One or more SDMs may define multiple architectures that are accessed by the capacity planning system and methods. Each architecture definition includes information regarding various options and constraints associated with the architecture. The SDM may also contain information collected from one or more live systems, such as performance data and configuration information for the various components in the system.

The SDM contains static information (e.g., the topology of software services within an application) and dynamic information (e.g., the control flow of a particular transaction). This information is used to describe components, system architecture, and transaction flows (e.g., a series of steps that perform a function).

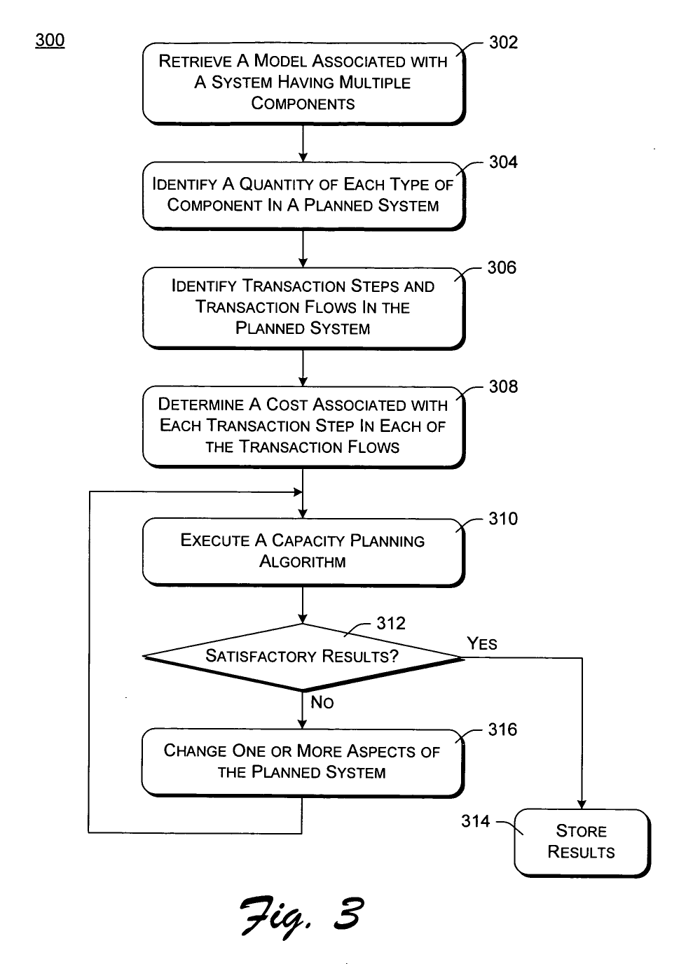

FIG. 3 is a flowchart illustrating an example process 300 for capacity planning. Process 300 can be implemented in software, firmware, and/or hardware. A “planned system” may be an existing system, proposed modifications to an existing system, or a new system not yet implemented.

Initially, process 300 retrieves a model associated with a system having multiple components (block 302). In one embodiment, this model is an SDM model of the type discussed above with respect to FIGS. 1 and 2. A planned system can be defined as a hypothetical system that might be implemented depending on the results of the capacity planning process. Alternatively, a planned system may include at least a portion of an existing system (e.g., an expansion or modification of an existing system). In this situation, certain data (such as performance data) associated with the existing system may be used in modeling the planned system.

The procedure continues by identifying a quantity of each type of component in a planned system (block 304). In a particular embodiment, the SDM is scale invariant. For example, the SDM may contain information about different types of components, but does not necessarily indicate the number (or quantity) of each type of component in a specific system. To properly identify the characteristics and requirements of a specific system, it is important to know the number of components involved in the system and their expected (or actual) interactions with one another. Procedure 300 identifies transaction steps and transaction flows in the planned system (block 306). These transaction steps and transaction flows are useful in determining resources (e.g., storage capacities, communication bandwidth, etc.) in the planned system.

Procedure 300 continues by determining a cost associated with each transaction step in each of the transaction flows (block 308). A “cost” can vary depending on the transaction and/or the step being discussed. For example, a cost can be time, bandwidth, storage capacity, processing capacity, and the like. This cost information can be stored in the SDM using one or more information pages associated with one or more components. Alternatively, the cost information can be stored separately from the SDM. A particular transaction may include multiple different steps. In this situation, a cost is associated with each of the multiple steps and a cost is associated with the various transitions between the multiple steps.

Next, the procedure executes a capacity planning algorithm (block 310). The capacity planning algorithm simulates the actions taken by an application as it runs on a distributed system. The simulated application, users, hardware, and workload can be modified to see the likely effects of the modification on the throughput, latency, etc. of the application, and the utilization of the hardware. This simulation eliminates the need to build and test a real system in a test lab or similar setting. Various types of capacity planning approaches include simulation, statistical analysis (e.g., trending), operational research analytics, queuing theory, or a hybrid approach (e.g., a combination of any two or more approaches).

If the capacity planning algorithm returns satisfactory results (block 312), the results of the capacity planning algorithm are stored (block 314) along with information about the planned system. If the capacity planning algorithm does not return satisfactory results, one or more aspects of the planned system are changed (block 316). Satisfactory results include, for example, worst-case time to process a transaction, maximum wait time for a response, average wait time for a response, maximum number of concurrent requests, and the like. Changes to a planned system may include increasing storage capacity, increasing processing resources, increasing communication bandwidth between certain components, adding components, removing components, etc.

When performing the capacity planning process, different system architectures may be considered. Other variables may include different numbers of servers or other components, different component sizes and component configurations, different storage capacities, and different types and quantities of transactions. These different architectures and/or variables allow a wide range of differences among various planned systems to see which system is best suited for the anticipated transactions.

In a particular embodiment, a planned system is defined by an SDM as well as additional information regarding the various transactions to be executed, including the cost of each step in each transaction. In other embodiments, all information about the planned system is contained in an SDM.

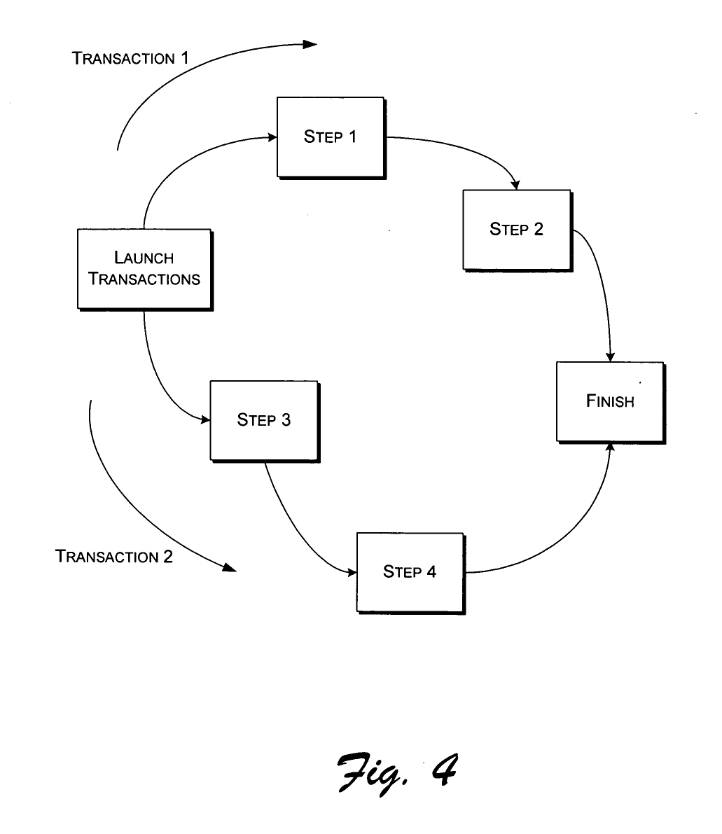

FIG. 4 illustrates example transactions that are performed by a planned system. In this example, two separate transactions are launched in response to a particular request. For example, a customer may place an order for a particular product. In other implementations, each transaction may be executed independently of the other transaction. A first transaction (Transaction 1) performs an inventory check to determine whether the requested product is available and, if not available, determine a reasonable time required to obtain and deliver the product to the customer. A second transaction (Transaction 2) performs a credit check to be sure the customer is authorized to purchase the requested product.

For example, Step 1 and Step 2 of Transaction 1 represent steps necessary to perform an inventory check, such as looking up a product identification code, querying one or more warehouse databases to see if the product is in stock, etc. Step 3 and Step 4 of Transaction 2 represent steps necessary to perform a credit check, such as verifying past account payments, verifying credit card information, and the like.

When evaluating a planned system, an estimation is performed to determine an approximate number of transactions performed in a given time period. For example, if an average of ten separate inventory queries are performed for each order that is placed, and the system is expecting 5000 orders per day, then there are 50,000 expected inventory queries per day. Additionally, the planned system may be expected to maintain 25,000 different product identifiers in a product database. These parameters, along with various system model information from the SDM and other information regarding the planned system are used by a capacity planning algorithm to estimate the performance of the planned system. If the performance of the system is not satisfactory, changes are made to the planned system and the capacity planning algorithm is run again to identify the results of the changes.

In one example, a first planned system has a bottleneck created by a hard disk drive. The speed and the capacity of the hard disk drive is upgraded to create a second planned system. This second planned system encounters a bottleneck caused by lack of processor resources to handle all of the necessary operations. Thus, an additional processor or a faster processor is added to the second planned system to create a third planned system. This process continues until all a planned system is defined that is estimated to produce satisfactory results based on the capacity planning algorithm.

Referring to the example of FIG. 4, each step (Step 1, Step 2, Step 3, Step 4) has an associated cost, which is measured in time required to perform the step as well as storage capacity and processor capacity required to perform the step. Transitions between steps may also have associated costs, such as time required to transition from one step to the next and bandwidth required to communicate data from one step to the next or to communicate data between different components in the planned system. These costs may be estimated based on an administrator's knowledge of similar systems or past experience with similar systems. Alternatively, one or more of these costs can be determined based on actual results from an existing system. For example, if the planned system is a modification of an existing system, performance data from the existing system may be used to estimate similar performance data in the modified system.

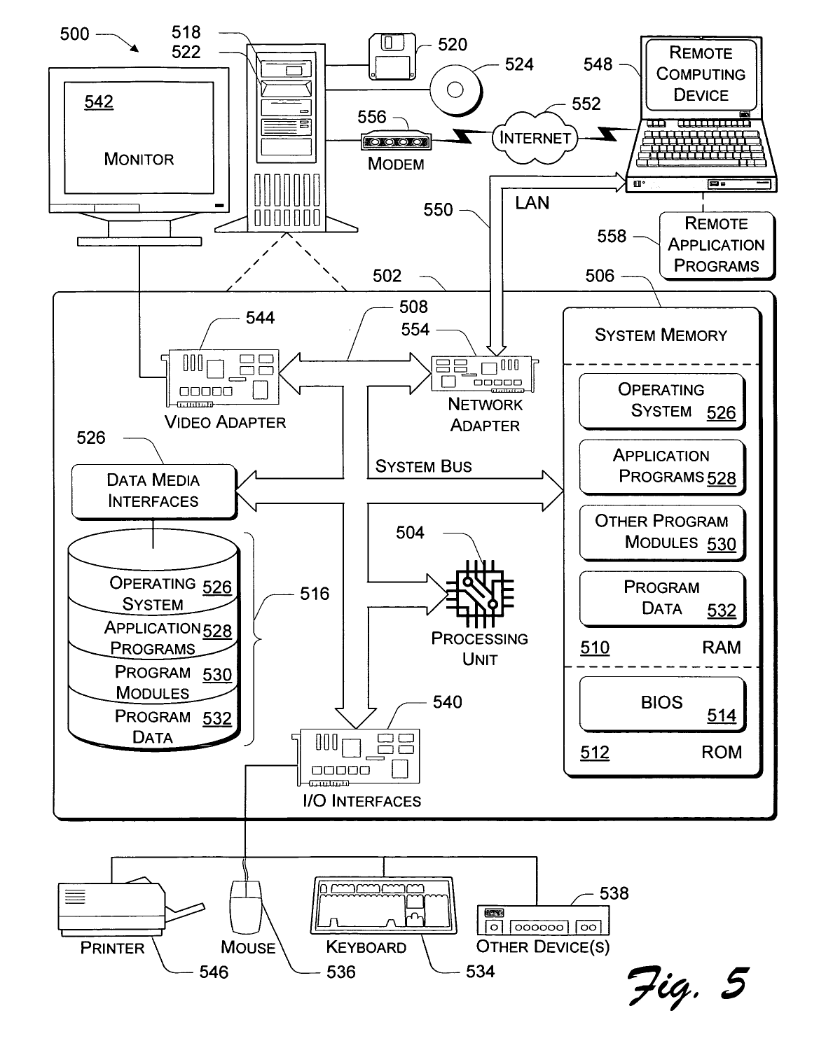

FIG. 5 illustrates an example general computer environment 500, which can be used to implement the techniques described herein. The computer environment 500 is only one example of a computing environment and is not intended to suggest any limitation as to the scope of use or functionality of the computer and network architectures. Neither should the computer environment 500 be interpreted as having any dependency or requirement relating to any one or combination of components illustrated in the example computer environment 500.

Computer environment 500 includes a general-purpose computing device in the form of a computer 502. Computer 502 can be, for example, a desktop computer, a handheld computer, a notebook or laptop computer, a server computer, a game console, and so on. The components of computer 502 can include, but are not limited to, one or more processors or processing units 504, a system memory 506, and a system bus 508 that couples various system components including the processor 504 to the system memory 506.

The system bus 508 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 502 typically includes a variety of computer readable media. Such media can be any available media that is accessible by computer 502 and includes both volatile and non-volatile media, removable and non-removable media.

The system memory 506 includes computer readable media in the form of volatile memory, such as random access memory (RAM) 510, and/or non-volatile memory, such as read only memory (ROM) 512. A basic input/output system (BIOS) 514, containing the basic routines that help to transfer information between elements within computer 502, such as during start-up, is stored in ROM 512. RAM 510 typically contains data and/or program modules that are immediately accessible to and/or presently operated on by the processing unit 504.

Computer 502 may also include other removable/non-removable, volatile/non-volatile computer storage media. By way of example, FIG. 5 illustrates a hard disk drive 516 for reading from and writing to a non-removable, non-volatile magnetic media (not shown), a magnetic disk drive 518 for reading from and writing to a removable, non-volatile magnetic disk 520 (e.g., a “floppy disk”), and an optical disk drive 522 for reading from and/or writing to a removable, non-volatile optical disk 524 such as a CD-ROM, DVD-ROM, or other optical media. The hard disk drive 516, magnetic disk drive 518, and optical disk drive 522 are each connected to the system bus 508 by one or more data media interfaces 526. Alternatively, the hard disk drive 516, magnetic disk drive 518, and optical disk drive 522 can be connected to the system bus 508 by one or more interfaces (not shown).

The disk drives and their associated computer-readable media provide non-volatile storage of computer readable instructions, data structures, program modules, and other data for computer 502. Although the example illustrates a hard disk 516, a removable magnetic disk 520, and a removable optical disk 524, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 516, magnetic disk 520, optical disk 524, ROM 512, and/or RAM 510, including by way of example, an operating system 526, one or more application programs 528, other program modules 530, and program data 532. Each of such operating system 526, one or more application programs 528, other program modules 530, and program data 532 (or some combination thereof) may implement all or part of the resident components that support the distributed file system.

A user can enter commands and information into computer 502 via input devices such as a keyboard 534 and a pointing device 536 (e.g., a “mouse”). Other input devices 538 (not shown specifically) may include a microphone, joystick, game pad, satellite dish, serial port, scanner, and/or the like. These and other input devices are connected to the processing unit 504 via input/output interfaces 540 that are coupled to the system bus 508, but may be connected by other interface and bus structures, such as a parallel port, game port, or a universal serial bus (USB).

A monitor 542 or other type of display device can also be connected to the system bus 508 via an interface, such as a video adapter 544. In addition to the monitor 542, other output peripheral devices can include components such as speakers (not shown) and a printer 546 which can be connected to computer 502 via the input/output interfaces 540.

Computer 502 can operate in a networked environment using logical connections to one or more remote computers, such as a remote computing device 548. By way of example, the remote computing device 548 can be a personal computer, portable computer, a server, a router, a network computer, a peer device or other common network node, and the like. The remote computing device 548 is illustrated as a portable computer that can include many or all of the elements and features described herein relative to computer 502.

Logical connections between computer 502 and the remote computer 548 are depicted as a local area network (LAN) 550 and a general wide area network (WAN) 552. Such networking environments are commonplace in offices, enterprise-wide computer networks, intranets, and the Internet.

When implemented in a LAN networking environment, the computer 502 is connected to a local network 550 via a network interface or adapter 554. When implemented in a WAN networking environment, the computer 502 typically includes a modem 556 or other means for establishing communications over the wide network 552. The modem 556, which can be internal or external to computer 502, can be connected to the system bus 508 via the input/output interfaces 540 or other appropriate mechanisms. It is to be appreciated that the illustrated network connections are exemplary and that other means of establishing communication link(s) between the computers 502 and 548 can be employed.

In a networked environment, such as that illustrated with computing environment 500, program modules depicted relative to the computer 502, or portions thereof, may be stored in a remote memory storage device. By way of example, remote application programs 558 reside on a memory device of remote computer 548. For purposes of illustration, application programs and other executable program components such as the operating system are illustrated herein as discrete blocks, although it is recognized that such programs and components reside at various times in different storage components of the computing device 502, and are executed by the data processor(s) of the computer.

Various modules and techniques may be described herein in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

Alternatively, portions of the framework may be implemented in hardware or a combination of hardware, software, and/or firmware. For example, one or more application specific integrated circuits (ASICs) or programmable logic devices (PLDs) could be designed or programmed to implement one or more portions of the framework.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method comprising:
accessing a model of a planned system that includes a plurality of components, wherein the model is a system definition model that describes the planned system;
identifying relationships among the plurality of components based on the model of the system;
identifying transactions to be performed by the planned system;
identifying a cost associated with each of the identified transactions; and
simulating operation of the planned system using the model of the planned system and the identified costs.

2. A method as recited in claim 1, wherein the model of the planned system is defined during development of the plurality of components.

3. A method as recited in claim 1, wherein identifying transactions to be performed by the planned system includes identifying a plurality of transaction steps associated with each transaction to be performed by the planned system.

4. A method as recited in claim 1, further comprising determining whether the planned system is expected to operate in a satisfactory manner.

5. A method as recited in claim 4, further comprising modifying the planned system if the planned system is not expected to operate in a satisfactory manner.

6. A method as recited in claim 1, wherein the cost associated with each of the identified transactions includes a time required to perform each of the identified transactions.

7. A method as recited in claim 1, wherein the cost associated with each of the identified transactions includes storage resources needed to perform each of the identified transactions.

8. A method as recited in claim 1, wherein the cost associated with each of the identified transactions includes storage resources and processing resources needed to perform each of the identified transactions.

9. A method as recited in claim 1, wherein the cost associated with each of the identified transactions is contained in the model of the planned system.

10. A method comprising:
accessing a model of a planned system that includes a plurality of components, wherein the model is a system definition model that describes the planned system;
identifying relationships among the plurality of components based on the model of the system;
identifying transactions to be performed by the planned system, wherein each transaction includes at least one step;
identifying a cost associated with each step of the identified transactions;
simulating operation of the planned system using the model of the planned system; and
modifying the planned system if simulating operation of the planned system products undesirable results.

11. A method as recited in claim 10, wherein simulating operation of the planned system includes executing a capacity planning algorithm.

12. A method as recited in claim 10, further comprising simulating operation of the modified planned system.

13. A method as recited in claim 10, wherein the planned system represents a modification of an existing system.

14. A method as recited in claim 13, wherein the cost associated with each step of the identified transactions is determined based on performance information associated with the existing system.

15. A method as recited in claim 10, wherein the cost associated with each step of the identified transactions includes at least one of: time, storage resources, or processor resources.

16. A method as recited in claim 10, further comprising identifying a cost associated with transitions between steps of the identified transactions.

17. One or more computer readable media having stored thereon a plurality of instructions that, when executed by one or more processors, causes the one or more processors to:
identify a plurality of components in a system and relationships among the plurality of components based on information contained in a system definition model;
identify proposed changes to the system;
identifying at least one transaction to be performed by the changed system;
identifying at least one cost associated with the transaction; and
simulating operation of the changed system.

18. One or more computer readable media as recited in claim 17, wherein the at least one cost associated with the transaction includes a cost associated with each step of the transaction.

19. One or more computer readable media as recited in claim 17, wherein simulating operation of the system includes executing a capacity planning algorithm.

20. One or more computer readable media as recited in claim 17, wherein identifying at least one cost associated with the transaction includes identifying a cost associated with a step contained in the transaction.
